(19) United States
(12) Patent Application Publication
(10) Pub. No.: US 2007/0268215 A1
(43) Pub. Date: Nov. 22, 2007

(54) DRIVING A PLASMA DISPLAY PANEL

(75) Inventors: Seonghwan RYU, Guri-si (KR); Kirack PARK, Gyeongsangbuk-do (KR); Jongwoon BAE, Gumi-si (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/752,020

(22) Filed: May 22, 2007

(30) Foreign Application Priority Data
May 22, 2006 (KR) 10-2006-0045585

(51) Int. Cl. G09G 3/28

(52) U.S. Cl. 345/67

(57) ABSTRACT

A plasma display panel and method of driving the plasma display panel are described. The plasma display panel includes a scan electrode, a sustain electrode positioned in parallel to the scan electrode, an address electrode overlapping the scan electrode and the sustain electrode, a partition and a scan driver. The partition is configured to divide the address electrode into first and second sub-electrodes that are electrically isolated from one another. The scan driver is configured to apply a first scan signal to the scan electrode during a first subfield. The first subfield includes a reset period, a pre-reset period that immediately precedes the reset period, an address period and a sustain period.

This application claims the benefit of Korean Patent Application No. 10-2006-0045585 filed on May 22, 2006 which is hereby incorporated by reference.

### BACKGROUND

1. Field

This document relates to a plasma display apparatus.

2. Description of the Related Art

A plasma display apparatus includes a plasma display panel including a plurality of electrodes, and a driver supplying a predetermined driving signal to the electrodes of the plasma display panel.

The plasma display panel includes a phosphor layer positioned inside a discharge cell partitioned by barrier ribs. The driver supplies the predetermined driving signal to the discharge cell through the electrodes.

When the driving signal generates the discharge inside the discharge cells, a discharge gas filled in the discharge cells generates ultraviolet rays, which thereby cause phosphors formed inside the discharge cells to emit light, thus displaying an image on the screen of the plasma display panel.

### SUMMARY

In one general aspect, a plasma display panel includes a scan electrode, a sustain electrode positioned in parallel to the scan electrode, an address electrode overlapping the scan electrode and the sustain electrode, a partition and a scan driver. The partition is configured to divide the address electrode into a first sub-electrode and a second sub-electrode that are electrically isolated from one another. The scan driver is configured to apply a first scan signal to the scan electrode during a first subfield. The first subfield includes a reset period, a pre-reset period that immediately precedes the reset period, an address period and a sustain period.

In another general aspect, a plasma display panel includes a screen, a scan electrode, a sustain electrode positioned in parallel to the scan electrode, a scan driver and an address electrode positioned perpendicular to the scan electrode and the sustain electrode. The address electrode is divided for dividing the screen into smaller screens. The scan driver is configured to apply a first scan signal to the scan electrode during a first subfield.

In yet another general aspect, a method of driving a plasma display panel includes applying a first scan signal to a first scan electrode and a second scan electrode during a first subfield, applying a sustain signal to a sustain electrode during the first subfield, and applying an address signal to an address electrode during the first subfield.

Implementations may include one or more of the following features. For example, the scan driver may be further configured to apply a second scan signal to the scan electrode during a second subfield that follows the first subfield temporally. The second subfield may begin with a reset period. The scan driver may also be configured to apply a third scan signal to the scan electrode during a third subfield that follows the first subfield temporally. The third subfield may begin with a pre-reset period.

A sustain driver may apply a first sustain signal to the sustain electrode during the first subfield. The first sustain signal may be biased to a predetermined value during a period after the reset period of the first subfield, for example, the address period of the first subfield.

Each of the first sub-electrode and the second sub-electrode has a terminal portion near the partition, and the width of the terminal portion of the first sub-electrode or the second sub-electrode dictates the separation between the first sub-electrode and the second sub-electrode. The distance between the first sub-electrode and the second sub-electrode may range from 0.4 to 5 times or 0.6 to 2.5 times the width of the widest of the terminal portions of the first sub-electrode and the second sub-electrode.

The width of the address electrode at a portion where the address electrode overlaps the scan electrode or the sustain electrode is greater that the width of the address electrode at a non-overlapping portion of the address electrode. Also, the width of the address electrode at a portion where the address electrode overlaps the scan electrode is greater than the width of the address electrode at another portion where the address electrode overlaps the sustain electrode.

The first scan signal may have a rising voltage characteristic and a falling voltage characteristic during the reset period of the first subfield. Also, the first scan signal may have a first rising voltage characteristic and a second rising voltage characteristic during the reset period of the first subfield.

Other features will be apparent from the following description, including the drawings, and the claims.

### BRIEF DESCRIPTION OF THE DRAWINGS

The accompanying drawings, which are included to enhance understanding of various concepts and which are incorporated in and constitute a part of this specification, illustrate various implementations.

FIG. 1 illustrates a configuration of a plasma display apparatus;

FIG. 2 illustrates a structure of a plasma display panel of the plasma display apparatus;

FIG. 3 illustrates an exemplary frame structure for achieving a gray level of an image in the plasma display apparatus;

FIG. 4 illustrates exemplary signal waveforms applied to electrodes of the plasma display apparatus during one subfield of a frame;

FIG. 5 illustrates other exemplary signal waveforms applied to the scan and sustain electrodes;

FIG. 6 illustrates another exemplary waveform of a first signal supplied during a setup period of a reset period;

FIG. 7 illustrates other exemplary waveforms which may be supplied at the end of the set-down period;

FIGS. 8a and 8b illustrate a configuration of address electrodes;

FIG. 9 illustrates exemplary scanning signal waveforms for the configuration of address electrodes as in FIGS. 8a and 8b;

FIGS. 10a and 10b illustrate exemplary configurations of driver circuits;

FIG. 11 illustrates a division area of an address electrode in one configuration;

FIG. 12 illustrates a division area of an address electrode in another configuration;

FIG. 13 illustrates exemplary shapes of terminal portions of an address electrode near the division;

FIG. 14 illustrates another exemplary shape of the terminal portions of address electrodes near the division;

FIG. 15 illustrates an exemplary arrangement of discharge cells;

FIG. 16 illustrates another exemplary shape of the terminal portions of address electrodes near the division;

FIGS. 17a and 17b illustrate other exemplary shapes of the terminal portions of address electrodes near the division;

FIGS. 18a to 18c illustrate an exemplary arrangement of scan electrodes and sustain electrodes;

FIG. 19 illustrates another exemplary arrangement of scan electrodes and sustain electrodes; and

FIGS. 20a and 20b illustrate exemplary shapes of address electrodes.

### DETAILED DESCRIPTION

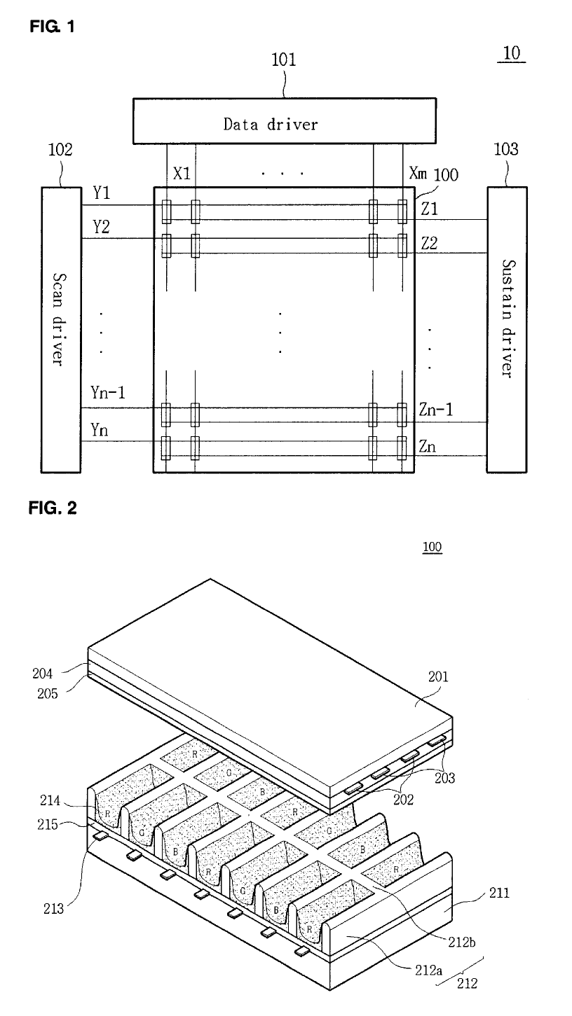

FIG. 1 illustrates a configuration of a plasma display apparatus.

Referring to FIG. 1, the plasma display apparatus 10 includes a plasma display panel 100, a scan driver 102, and a sustain driver 103. The plasma display apparatus may further include a data driver 101.

Although the scan driver 102, the sustain driver 103, and the data driver 101 are separately positioned in FIG. 1, at least two of the scan driver 102, the sustain driver 103, and the data driver 101 may be integrated into a single driver.

The scan driver 102 supplies driving signals to scan electrodes Y1 to Yn of the plasma display panel 100. The sustain driver 103 supplies driving signals to sustain electrodes Z1 to Zn of the plasma display panel 100. The data driver 101 supplies driving signals to address electrodes x1 to Xm of the plasma display panel 100.

The scan driver 102, the sustain driver 103, and the data driver 101 will be explained in detail later.

FIG. 2 illustrates a structure of a plasma display panel of the plasma display apparatus.

Referring to FIG. 2, the plasma display panel 100 includes a front substrate 201 and a rear substrate 211. On the front substrate 201, a scan electrode 202 and a sustain electrode 203 are formed in parallel to each other. On the rear substrate 211, an address electrode 213 is formed to overlap the scan electrode 202 and the sustain electrode 203.

The upper dielectric layer 204 for covering the scan electrode 202 and the sustain electrode 203 is formed on an upper portion of the front substrate 201 on which the scan electrode 202 and the sustain electrode 203 are formed.

The upper dielectric layer 204 limits discharge currents of the scan electrode 202 and the sustain electrode 203, and provides insulation between the scan electrode 202 and the sustain electrode 203.

A protective layer 205 is formed on an upper surface of the upper dielectric layer 204 to improve discharge conditions. The protective layer 205 includes a material having a high secondary electron emission coefficient, for example, magnesium oxide (MgO).

A lower dielectric layer 215 for covering the address electrode 213 is formed on an upper portion of the rear substrate 211 on which the address electrode 213 is formed. The lower dielectric layer 215 provides insulation for the address electrode 213.

Barrier ribs 212, which may be a stripe type, a well type, a delta type, a honeycomb type, and the like, are formed on an upper portion of the lower dielectric layer 215 to partition discharge spaces (i.e., discharge cells). A red (R) discharge cell, a green (G) discharge cell, and a blue (B) discharge cell, and the like, are formed between the front substrate 201 and the rear substrate 211.

In addition to the red (R), green (G), and blue (B) discharge cells, a white (W) discharge cell or a yellow (Y) discharge cell may be further formed between the front substrate 201 and the rear substrate 211.

The widths of the red (R), green (G), and blue (B) discharge cells may be substantially equal to one another. Alternatively, the width of at least one of the red (R), green (G), or blue (B) discharge cells may be different from the widths of the other discharge cells.

For instance, the width of the red (R) discharge cell may be the smallest.

The width of the green (G) discharge cell may be substantially equal to or different from the width of the blue (B) discharge cell.

The widths of the above-described discharge cells determine the width of a phosphor layer 214 formed inside the discharge cells. For example, the width of a blue (B) phosphor layer formed inside the blue (B) discharge cell may be greater than the width of a red (R) phosphor layer formed inside the red (R) discharge cell. Further, the width of a green (G) phosphor layer formed inside the green (G) discharge cell may be greater than the width of the red (R) phosphor layer formed inside the red (R) discharge cell.

As a result, a color temperature of an image displayed on the plasma display panel is improved.

The plasma display panel may have various forms of barrier rib structures. For instance, the barrier rib 212 includes a first barrier rib 212b and a second barrier rib 212a. The barrier rib 212 may have a differential type barrier rib structure in which the height of the first barrier rib 212b and the height of the second barrier rib 212a are different from each other, a channel type barrier rib structure in which a channel usable as an exhaust path is formed on at least one of the first barrier rib 212b or the second barrier rib 212a, a hollow type barrier rib structure in which a hollow is formed on at least one of the first barrier rib 212b or the second barrier rib 212a, and the like.

In the differential type barrier rib structure, the height of the first barrier rib 212b may be less than the height of the second barrier rib 212a. Further, in the channel type barrier rib structure, a channel may be formed on the first barrier rib 212b.

While the plasma display panel has been illustrated and described as having the red (R), green (G), and blue (B) discharge cells arranged on the same line, it is possible to arrange them in a different pattern. For instance, a delta type arrangement in which the red (R), green (G), and blue (B) discharge cells are arranged in a triangle shape may be applicable. Further, the discharge cells may form a variety of polygonal shapes such as pentagonal and hexagonal shapes as well as a rectangular shape.

While FIG. 2 has illustrated and described a case where the barrier rib 212 is formed on the rear substrate 211, the barrier rib 212 may be formed on at least one of the front substrate 201 or the rear substrate 211.

Each of the discharge cells partitioned by the barrier ribs 212 is filled with a predetermined discharge gas.

The phosphor layer 214 for emitting visible light for an image display when an address discharge is generated is formed inside the discharge cells partitioned by the barrier ribs 212. For instance, red (R), green (G) and blue (B) phosphor layers may be formed inside the discharge cells.

A white (W) phosphor layer and/or a yellow (Y) phosphor layer may also be formed in addition to the red (R), green (G) and blue (B) phosphor layers.

The thickness of at least one of the phosphor layers 214 formed inside the red (R), green (G) and blue (B) discharge cells may be different from the thicknesses of the other phosphor layers. For instance, the thicknesses of green (G) and blue (B) phosphor layers inside the green (G) and blue (B) discharge cells may be greater than the thickness of a red (R) phosphor layer inside the red (R) discharge cell. The thickness of the green (G) phosphor layer inside the green (G) discharge cell may be substantially equal to or different from the thickness of the blue (B) phosphor layer inside the blue (B) discharge cell.

It should be noted that although only one exemplary plasma display panel has been illustrated and described above, the implementation of the plasma display panel is not limited to the plasma display panel of the above-described structure. For instance, while the above description illustrates a case where the upper dielectric layer 204 and the lower dielectric layer 215 each are formed in the form of a single layer, at least one of the upper dielectric layer 204 and the lower dielectric layer 215 may be formed in the form of more than one layers.

A black layer (not illustrated) for absorbing external light may be further formed on the upper portion of the barrier rib 212 to prevent the reflection of the external light caused by the barrier rib 212.

Further, another black layer (not illustrated) may be further formed at a specific position of the front substrate 201 corresponding to the barrier rib 212.

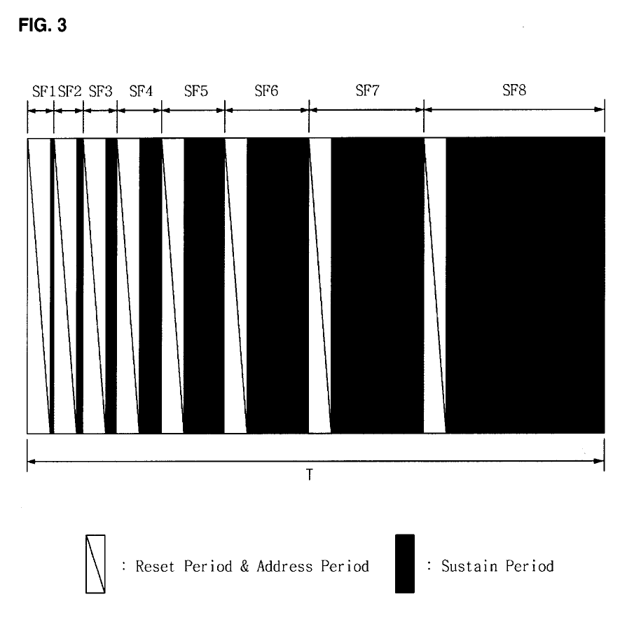

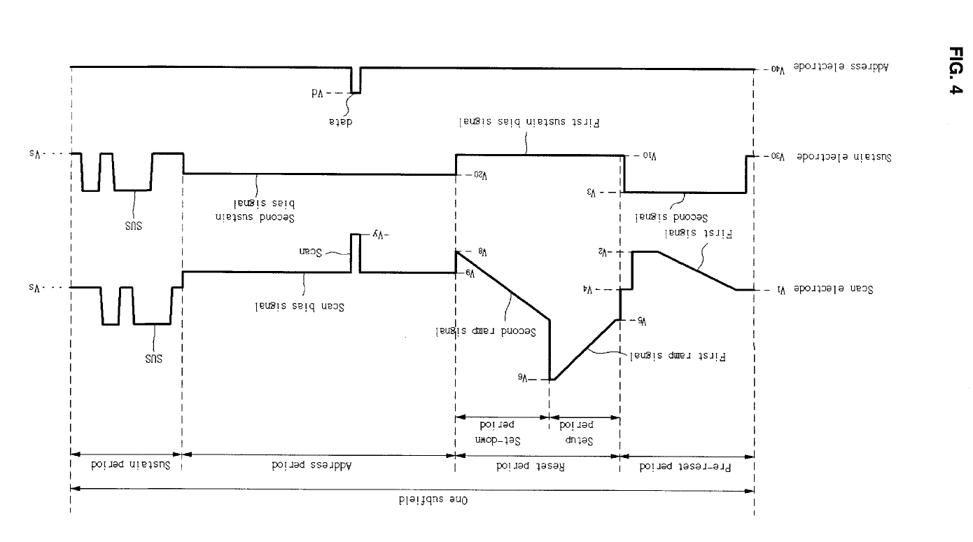

FIG. 3 illustrates an exemplary frame structure for achieving a gray level of an image displayed by the plasma display apparatus.

Referring to FIG. 3, a frame for achieving a gray level of an image is divided into several subfields each having a different emission time duration.

Each subfield is subdivided into a reset period for initializing all the cells, an address period for selecting cells to be discharged, and a sustain period for representing gray level in accordance with the number of discharges.

For example, if an image with 256 gray levels is to be displayed, a frame, as illustrated in FIG. 3, is divided into 8 subfields SF1 to SF8. Each of the 8 subfields SF1 to SF8 is subdivided into a reset period, an address period, and a sustain period.

The number of sustain signals supplied during the sustain period determines a gray level weight in each of the subfields. For example, in order to set the gray level weight of the first subfield to 2⁰ and the gray level weight of the second subfield to 2¹ and so on, the duration of the sustain period increases in a ratio of 2ⁿ (where, n=0, 1, 2, 3, 4, 5, 6, 7) for each of the subfields. Since the duration of the sustain period varies from one subfield to the next subfield, a specific gray level is achieved by choosing subfields with appropriate durations of sustain periods and controlling these subfields to emit light.

The plasma display panel uses frames to display an image during 1 second. For example, 60 frames are used to display an image during 1 second. In this case, a duration T of one frame may be 1/60 seconds, i.e., 16.67 ms.

Although FIG. 3 has illustrated and described a case where one frame includes 8 subfields, the number of subfields constituting one frame may vary. For example, one frame may include 12 subfields or 10 subfields.

Further, although FIG. 3 has illustrated and described subfields arranged in increasing order of gray level weight, the subfields may be arranged in decreasing order of gray level weight, or the subfields may be arranged regardless of gray level weight.

FIG. 4 illustrates an exemplary driving method of the plasma display apparatus.

The scan driver 102 of FIG. 1 supplies a first signal to the scan electrode during a pre-reset period prior to a reset period.

The sustain driver 103 supplies a second signal to the sustain electrode during the pre-reset period.

The first signal may be a ramp signal gradually falling from a first voltage V1 to a second voltage V2 that is lower than the first voltage V1. The slope of the first signal falling from the first voltage V1 to the second voltage V2 may range between 1.2 V/μs and 2.3 V/μs.

The first voltage V1 may be a ground level voltage GND.

The second signal rises from a thirtieth voltage V30 to a third voltage V3, and then is maintained at the third voltage V3. The third voltage V3 may be substantially equal to a highest voltage (i.e., a sustain voltage Vs) of a sustain signal SUS which will be supplied during a sustain period.

When the first signal is supplied to the scan electrode and the second signal is supplied to the sustain electrode during the pre-reset period, as explained above, wall charges of a predetermined polarity are accumulated on the scan electrode, and wall charges of the opposite polarity are accumulated on the sustain electrode. For example, wall charges of positive polarity are accumulated on the scan electrode, and wall charges of negative polarity are accumulated on the sustain electrode.

As a result, a setup discharge with a sufficient strength occurs during the reset period such that the initialization of all the discharge cells is performed stably. Further, even when the amount of wall charges inside the discharge cells is not sufficient, a setup discharge with a sufficient strength occurs.

Furthermore, even when a voltage of a first ramp signal supplied to the scan electrode during the reset period is low, a setup discharge with a sufficient strength occurs.

A frame may consist of more than one subfield. Among these subfields, only the first subfield may include a pre-reset period prior to a reset period so as to obtain sufficient driving time. Alternatively, two or three (or more) subfields of a single frame may include a pre-reset period prior to a reset period.

Although FIG. 4 illustrates and describes the first signal as a ramp signal gradually falling from the first voltage V1 to the second voltage V2, another form of the first signal is applicable.

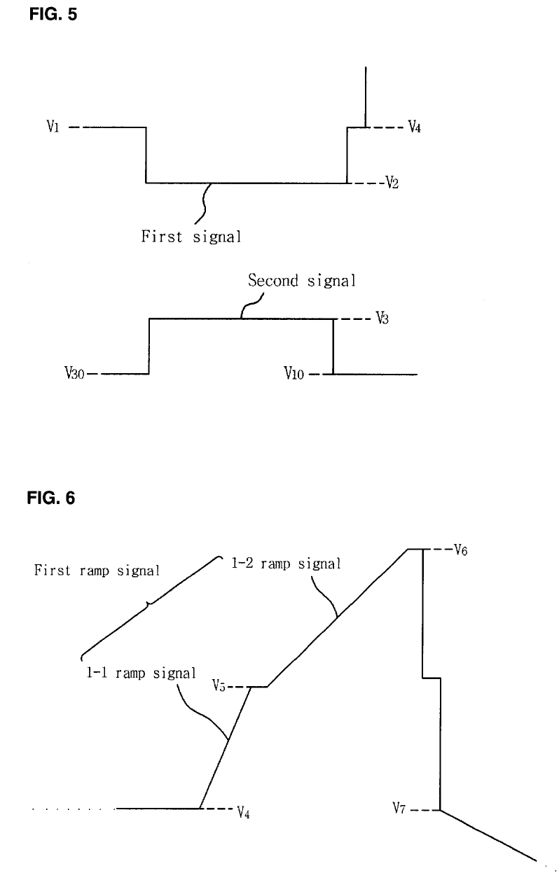

FIG. 5 illustrates another exemplary waveform of the first signal.

Referring to FIG. 5, the first signal supplied to the scan electrode sharply falls from the first voltage V1 to the second voltage V2, and then is substantially maintained at the second voltage V2.

In this case, wall charges of positive polarity are accumulated on the scan electrode, and wall charges of negative polarity are accumulated on the sustain electrode. This results in the generation of a setup discharge with a sufficient strength during the reset period such that the initialization of all the discharge cells is performed stably.

Referring again to FIG. 4, the scan driver 102 supplies a first ramp signal to the scan electrode during a setup period of the reset period. The direction of change of the first ramp signal is opposite to that of the first signal.

The first ramp signal gradually rises from a fifth voltage V5, that is higher than the second voltage V2 of the first signal, to a sixth voltage V6 with a predetermined slope. The sustain driver 103 supplies a first sustain bias signal to the sustain electrode. The first sustain bias signal is substantially maintained at a tenth voltage V10, which is lower than the third voltage V3 of the second signal.

The first ramp signal generates a weak dark discharge (i.e., a setup discharge) inside the discharge cells during the setup period, thereby accumulating a proper amount of wall charges inside the discharge cells.

After supplying the first ramp signal, the scan driver 102 supplies a second ramp signal to the scan electrode during a set-down period. The second ramp signal changes in the opposite direction of the first ramp signal.

The second ramp signal gradually falls from a predetermined voltage, that is lower than the sixth voltage V6 of the first ramp signal, to an eighth voltage V8.

The sustain driver 103 supplies the first sustain bias signal, that is substantially maintained at the tenth voltage V10, to the sustain electrode during the set-down period.

This results in the generation of a weak erase discharge (i.e., a set-down discharge) inside the discharge cells. Furthermore, the remaining wall charges are uniformly distributed inside the discharge cells to the extent that an address discharge can be stably performed.

FIG. 6 illustrates another exemplary waveform of the first signal supplied during the setup period of the reset period.

Referring to FIG. 6, the first ramp signal includes a 1-1 ramp signal and a 1-2 ramp signal, each having a different slope.

The 1-1 ramp signal gradually rises from the fourth voltage V4 to the fifth voltage V5 with a first rising slope. The 1-2 ramp signal gradually rises from the fifth voltage V5 to the sixth voltage V6 with a second rising slope.

With the successive supplying of the 1-1 ramp signal and the 1-2 ramp signal, the voltage on the scan electrode rises during the reset period, while preventing the generation of the instantaneous strong setup discharge. This results in a reduction in a magnitude of the dark discharge generated during the setup period.

The reduction in the magnitude of the dark discharge improves a contrast characteristic.

Referring again to FIG. 4, during an address period, the scan driver 102 supplies a scan bias signal maintained at a ninth voltage V9, that is higher than the eighth voltage V8 of the second ramp signal, to the scan electrode.

The scan driver 102 also supplies a scan signal (Scan) during the address period to the scan electrode, which falls from the scan bias signal to a negative scan voltage −Vy, is maintained at the voltage −Vy, and returns to the scan bias signal (voltage level V9).

Scan signals are applied to scan electrodes respectively. For example, first, second, . . . , n-th scan signals (Scan1, Scan2, . . . , Scan-n) are applied to the first, second, . . . , n-th scan electrodes, respectively.

The width of the scan signal, that is, the duration during which the voltage is maintained at −Vy in FIG. 4, may vary from one subfield to another subfield. In other words, the width of a scan signal in at least one subfield may be different from the widths of scan signals in other subfields. For example, the width of a scan signal in a subfield may be more than the width of a scan signal in a subsequent subfield.

For example, the widths of the scan signals may be gradually reduced through the subfields in the order of 2.6 μs, 2.3 μs, 2.1 μs, 1.9 μS, etc., or in the order of 2.6 μs, 2.3 μS, 2.3 μs, 2.1 μs, 1.9 μs, 1.9 μs, etc.

When the scan driver 102 supplies the scan signal to the scan electrode, the data driver 101 supplies a data signal corresponding to the scan signal to the address electrode.

As the voltage difference between the scan signal and the data signal is added to the wall voltage generated during the reset period, the address discharge is generated within the discharge cell to which the data signal is supplied.

The sustain driver 103 supplies a second sustain bias signal to the sustain electrode during the address period to prevent the generation of an unstable address discharge caused by interference of the sustain electrode. The second sustain bias signal rises from the tenth voltage V10 of the first sustain bias signal to a twentieth voltage V20, and then is substantially maintained at the twentieth voltage V20.

In other words, the first sustain bias signal is applied to the sustain electrode during the set-down period, and then the second sustain bias signal is applied at an end of the set-down period.

Since the first sustain bias signal having the tenth voltage V10 is supplied during the set-down period, the amount of wall charges erased during the set-down period is reduced such that a sufficient amount of wall charges remains inside the discharge cells during the address period. Therefore, the address discharge is performed stably and rapidly during the address period using a sufficient amount of wall charges.

The width of the scan signal (Scan) is reduced by the rapid and stable address discharge, securing sufficient driving time.

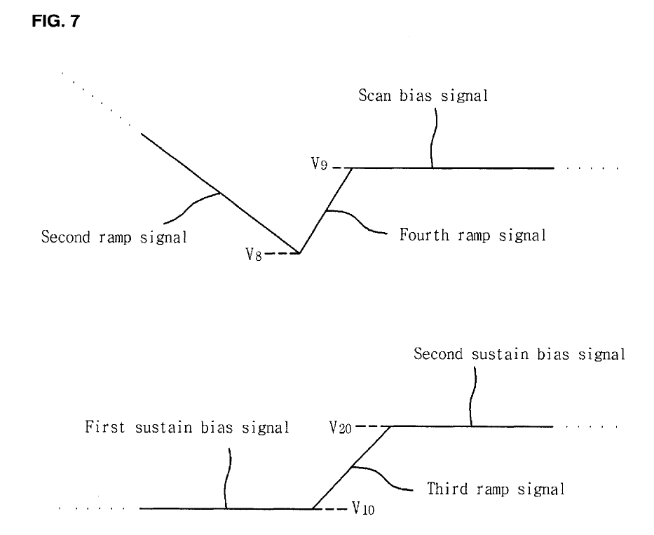

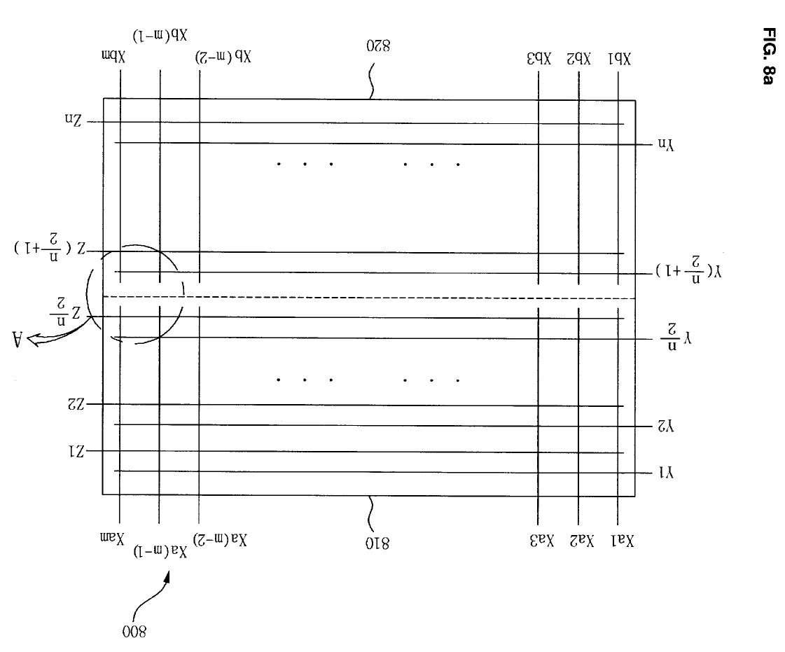

FIG. 7 illustrates other exemplary waveforms which may be supplied at the end of the set-down period.

Referring to FIG. 7, the sustain driver 103 supplies the first sustain bias signal during the reset period, and supplies the second sustain bias signal during the address period. The sustain driver 103 further supplies a third ramp signal to the sustain electrode, which gradually rises from the tenth voltage V10 to the twentieth voltage v20.

After supplying the second ramp signal, the scan driver 102 supplies a fourth ramp signal, which gradually rises from the eighth voltage V8 to the ninth voltage V9, to the scan electrode.

When the fourth ramp signal is supplied to the scan electrode and the third ramp signal is supplied to the sustain electrode, voltages on the scan electrode and sustain electrode change slowly such that a coupling effect between adjacent electrodes is reduced. Further, the generation of noise and electromagnetic interference (EMI) is reduced.

Referring again to FIG. 4, during the sustain period, at least one of the scan driver 102 and the sustain driver 103 may supply a sustain signal to at least one of the scan electrode and the sustain electrode. For example, the scan driver 102 and the sustain driver 103 respectively supply sustain signals (SUS) to the scan electrode and the sustain electrode.

As the wall voltage within the discharge cell selected by performing the address discharge is added to the sustain voltage Vs of the sustain signal (SUS), every time the sustain signal (SUS) is supplied, the sustain discharge, i.e., a display discharge, occurs between the scan electrode and the sustain electrode.

Further, the sustain signal (SUS) may be supplied to either the scan electrode or the sustain electrode. For example, while the sustain signal (SUS), as illustrated in FIG. 4, is supplied to one of the scan electrode and the sustain electrode, the other electrode may be maintained at the ground level voltage GND.

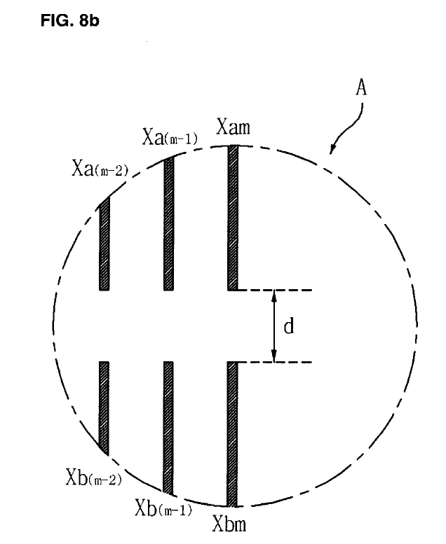

FIGS. 8a and 8b illustrate a configuration of address electrodes.

Referring to FIG. 8a, a plasma display panel 800 of a plasma display apparatus includes a first area 810 and a second area 820. Each of the address electrode is divided into a first sub-electrode placed in the first area 810 and a second sub-electrode placed in the second area 820. The first and second sub-electrode are electrically isolated, relative to one another. To put it another way, the first area 810 includes a first group of address electrodes Xa1, Xa2 . . . . Xam. The second area 820 includes a second group of address electrodes Xb1, Xb2 . . . . Xbm.

In the first area 810, the first group address electrodes Xa are arranged in parallel. In the second area 820, the second group address electrodes Xb are arranged in parallel opposite to the first group address electrodes Xa.

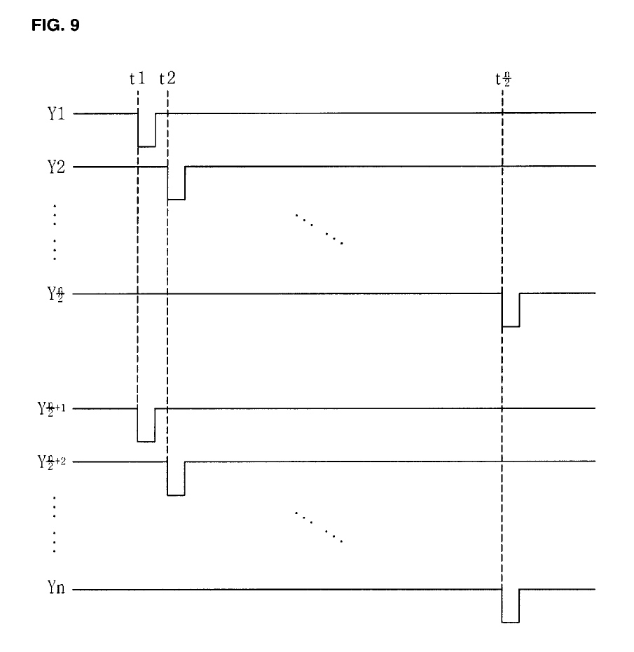

A reason to divide the address electrode into the first address electrode and the second address electrode will be described with reference to FIG. 9.

FIG. 9 illustrates an exemplary scanning operation for the configuration of address electrodes, as illustrated in FIGS. 8a and 8b.

In a case where at least one subfield of a frame includes a pre-reset period prior to a reset period, as previously described, a stable reset discharge occurs by sufficiently accumulating wall charges inside the discharge cells during the pre-reset period. However, the pre-reset period increases the duration of the subfield including the pre-reset period. Therefore, it is likely that the total driving time becomes insufficient.

However, when the address electrodes are divided into the first group address electrodes and the second group address electrodes, which are respectively placed in the first area 810 and the second area 820, the supplying of the scan signals to the scan electrodes arranged in the first area and the supplying of the scan signals to the scan electrodes arranged in the second area are performed simultaneously.

For example, as illustrated in FIG. 9, at a time point t1, the supplying of a scan signal to a first scan electrode Y1 in the first area 810 and the supplying of a scan signal to a (n/2+1)th scan electrode Y(n/2+1) in the second area 820 are performed simultaneously.

Next, at a time point t2, the supplying of a scan signal to a second scan electrode Y2 in the first area 810 and the supplying of a scan signal to a (n/2+2)th scan electrode Y(n/2+2) in the second area 820 are performed simultaneously.

As above, since a scan signal is supplied to two scan electrodes simultaneously during the address period, the duration of the address period may be reduced to about 50%, compared with the sequential scanning of all the scan electrodes. Therefore, even when some subfields include the pre-reset period, sufficient driving time is secured and accordingly, a stable address discharge occurs.

FIG. 8b illustrates detailed structures of the address electrodes in area A of FIG. 8a, where the first group address electrodes Xa and the second group address electrodes xb are terminated.

Referring to FIG. 8b, address electrodes Xa(m−2), Xa(m−1), and Xam are opposite to address electrodes Xb(m−2), Xb(m−1), and Xbm with a distance d therebetween, respectively.

When the distance d between the first address electrode Xa and the second address electrode Xb is excessively small, noise is likely to increase due to a coupling effect between the first group address electrodes Xa and the second group address electrode Xb. On the other hand, when the distance d is excessively large, a strip shape noise is displayed in a boundary portion between the first area 810 and the second area 820.

Considering this, it is advantageous that the distance d ranges from 0.4 to 5 times the largest width of at least one of the first address electrode and the second address electrode. It is more advantageous that the distance d ranges from 0.6 to 2.5 times the largest width of at least one of the first address electrode and the second address electrode.

For example, the distance d may range from 50 μM to 300 μm or from 70 μm to 220 μm.

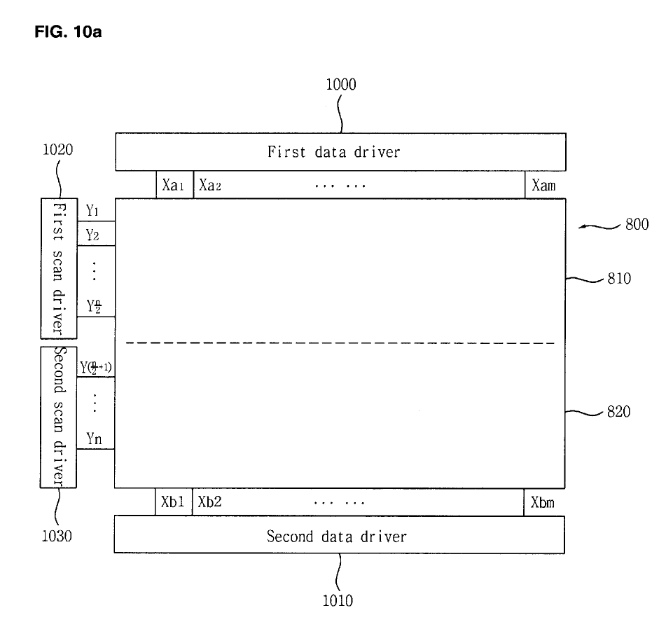

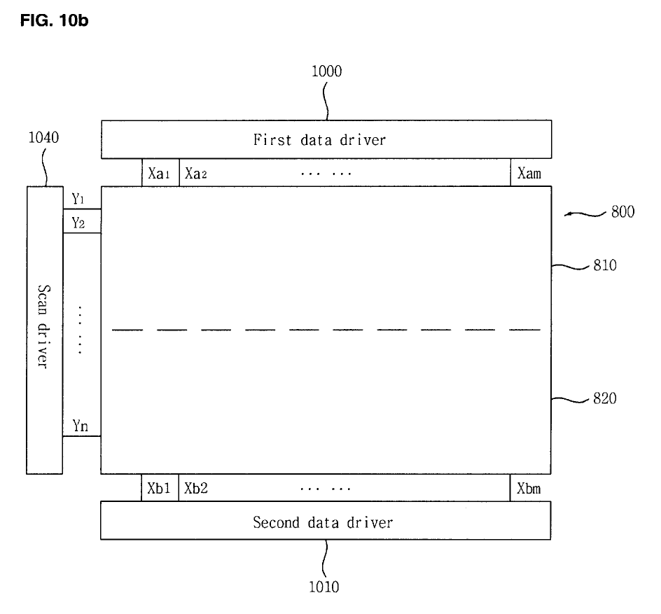

Driver circuits may be configured in many ways to drive the above type of plasma display panel. FIGS. 10a and 10b illustrate exemplary configurations of driver circuits.

Referring to FIG. 10a, a first data driver 1000 for supplying data signals to the first group address electrodes Xa, and a second data driver 1010 for supplying data signals to the second group address electrodes xb are positioned. In other words, the data driver is divided into the first data driver 1000 and the second data driver 1010 due to the division of the address electrode.

Further, the scan driver is divided into a first scan driver 1020 and a second scan driver 1030. The first scan driver 1020 supplies driving signals to the scan electrodes positioned in the first area 810. The second scan driver 1030 supplies driving signals to the scan electrodes positioned in the second area 820.

Referring to FIG. 10b, the first scan driver 1020 and the second scan driver 1030 of FIG. 10a may be combined into one scan driver 1040. In other words, one scan driver 1040 supplies driving signals to all the scan electrodes regardless of the division of the address electrodes.

As above, the driver circuit may be configured in various types.

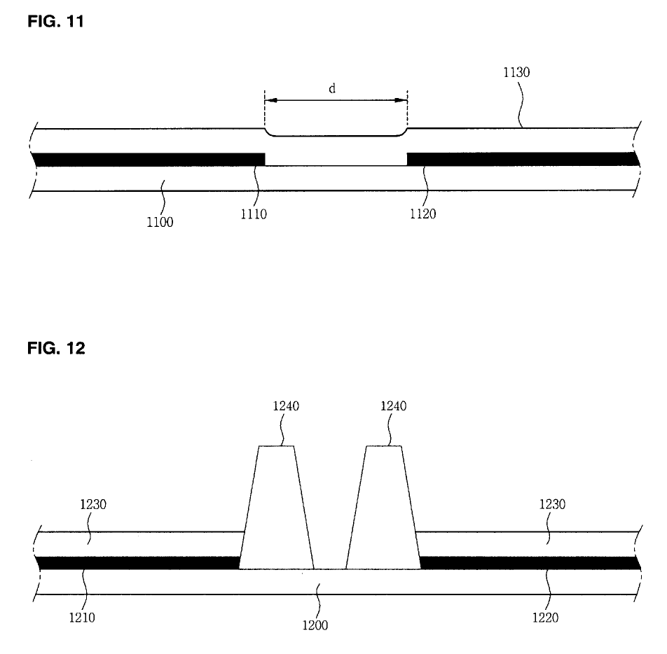

FIG. 11 illustrates a division area of an address electrode in one configuration.

Referring to FIG. 11, a first group address electrode 1110 and a second group address electrode 1120 are disposed opposite to each other with a distance d therebetween on a substrate 1100. To provide insulation between the first address electrode 1110 and the second address electrode 1120, a dielectric layer 1130 covering the first address electrode 1110 and the second address electrode 1120 is disposed. The substrate 1100 may be a rear substrate. The dielectric layer 1130 may be a white dielectric layer.

After the first group address electrode 1110 and the second group address electrode 1120 are formed as a single electrode on the substrate 1100, a portion corresponding to the distance d may be etched to divide the single electrode into the first group address electrode 1110 and the second group address electrode 1120. In other words, after the first address electrode 1110 and the second address electrode 1120 are formed in the form of one address electrode line, the first address electrode 1110 and the second address electrode 1120 are separated by removing a portion corresponding to the distance d from the first address electrode 1110 and the second address electrode 1120 using an etching method.

The thickness of the dielectric layer 1130 in an area between the first address electrode 1110 and the second address electrode 1120 may be greater than the thickness of the dielectric layer 1130 in other portion. Accordingly, electrical insulation between the first address electrode 1110 and the second address electrode 1120 increases.

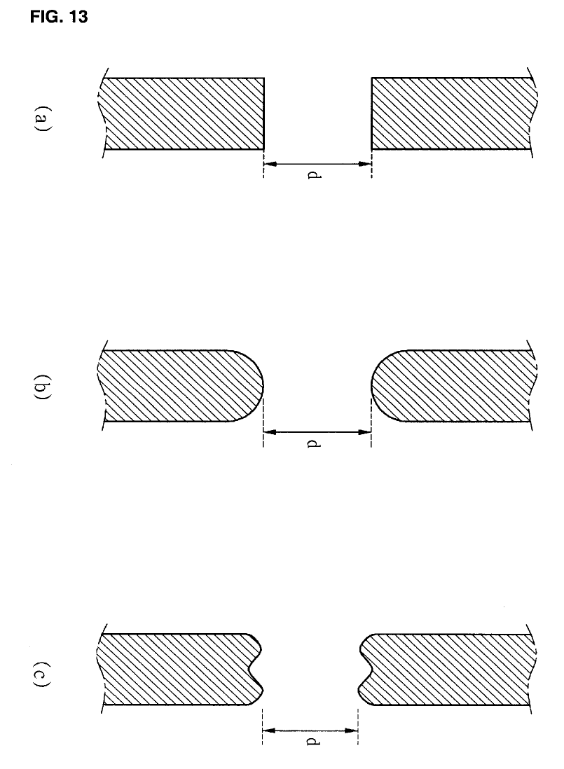

FIG. 12 illustrates a division area of an address electrode in another configuration.

Referring to FIG. 12, a first group address electrode 1210 and a second group address electrode 1220 are disposed opposite to each other on a substrate 1200. A dielectric layer 1230 covering the first group address electrode 1210 and the second group address electrode 1220 is disposed, and barrier ribs 1240 are formed between the first group address electrode 1210 and the second group address electrode 1220. The barrier ribs 1240 divide an address electrode line into the first group address electrode 1210 and the second group address electrode 1220.

In FIG. 12, two barrier ribs 1240 are positioned between the first group address electrode 1210 and the second group address electrode 1220. However, the number of barrier ribs 1240 may be set to 1 or 3.

FIG. 12 illustrates the barrier ribs 1240 as directly formed on the substrate 1200. However, the dielectric layer 1230 may be first formed on the substrate 1200, and then the barrier rib 1240 may be formed on the dielectric layer 1230.

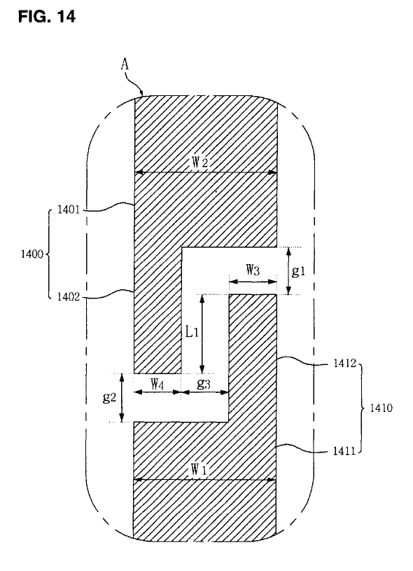

FIG. 13 illustrates exemplary shapes of terminal portions of an address electrode near the division.

As represented by (a) in FIG. 13, the terminal portion of an address electrode may be rectangular.

As represented by (b) in FIG. 13, the terminal portion may be round. As represented by (c) in FIG. 13, the terminal portion may be a concave shape in which a center portion of the end is depressed by a predetermined depth.

As above, the shape of the terminal portion of the address electrode may be varied.

FIG. 14 illustrates another exemplary shape of the terminal portions of address electrodes near the division. Referring to FIG. 14, first and second group address electrodes 1400 and 1410 have protruding portions 1402 and 1412 protruding toward each other. Therefore, the first address electrode 1400 overlaps the second address electrode 1410 by a length L1.

The shape of the terminal portions as illustrated in FIG. 14 increases the lengths of the terminal portions of the first group address electrode 1400 and the second group address electrode 1410. This prevents a sharp reduction in a voltage of a driving signal supplied to the discharge cells positioned near the division area.

Further, the generation of a weak discharge in the discharge cells positioned around the division area is prevented such that a discharge stability is improved.

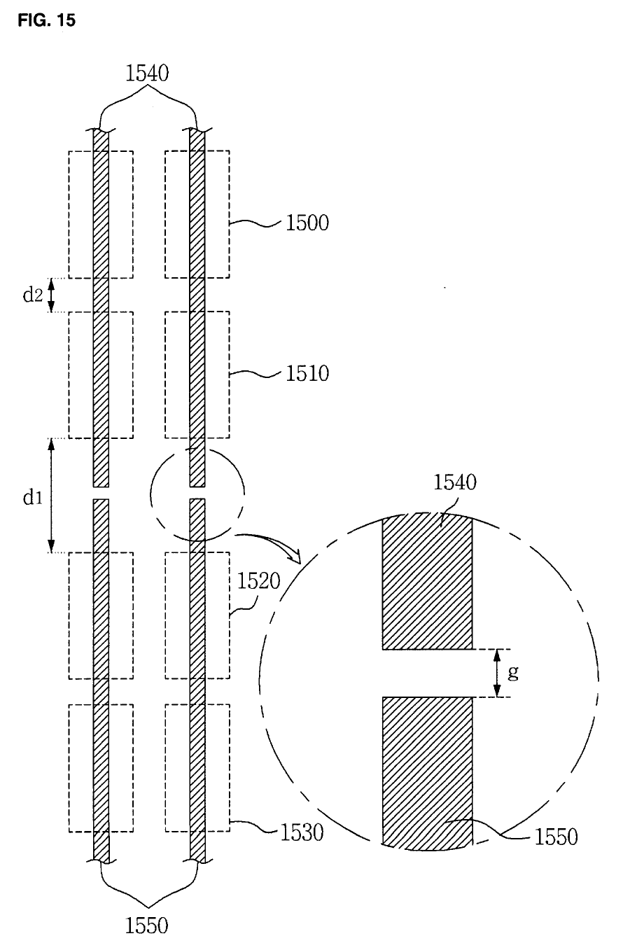

FIG. 15 illustrates an exemplary arrangement of discharge cells when address electrodes have rectangular shape terminal portions. Referring to FIG. 15, two first group address electrodes 1540 and two second group address electrodes 1550 are disposed opposite to each other with a distance g therebetween. Discharge cells 1500, 1510, 1520, and 1530 are placed over the address electrodes.

As explained, the shape of the terminal portions in FIG. 14 prevents sharp voltage reduction and unstable discharge near the terminal portions. In contrast, the rectangular shape terminal portion in FIG. 15 cannot prevent these problems. In FIG. 15, these problems are prevented by arranging discharge cells away from the terminal portions. In FIG. 15, a gap between discharge cells positioned over address electrodes of different groups is greater than a gap between discharge cells positioned over a same address electrode. For example, a gap d1 between a discharge cell 1510 and a discharge cell 1520 is greater than a gap d2 between a discharge cell 1500 and the discharge cell 1510.

As a result, a stripe-shaped noise may be seen between an image on a first area of the plasma display panel and an image on a second area of the plasma display panel, thereby worsening the image quality.

On the other hand, in FIG. 14, the generation of a black band is prevented on the screen by overlapping the first group address electrode 1400 and the second group address electrode 1410, and a stable discharge is generated.

when the length L1 of the overlap portion of the first address electrode 1400 and the second address electrode 1410 is excessively short, sharp voltage drop of the driving signal occurs in the terminal portions of the first group address electrode 1400 and the second group address electrode 1410. Therefore, an excessive weak discharge is generated in the discharge cell positioned in the overlap portion of the first group address electrode 1400 and the second group address electrode 1410, or there may be no discharge. On the other hand, when the length L1 of the overlap portion of the first group address electrode 1400 and the second group address electrode 1410 is excessively long, the problems illustrated in FIG. 15 may be generated.

Considering this, the length L1 of the overlap portion of the first group address electrode 1400 and the second group address electrode 1410 may range from 0.1 to 5 times or from 0.5 to 2 times the largest width (for example, the widths W1 and W2) of at least one of the first group address electrode 1400 or the second group address electrode 1410.

When one of the shortest gaps (for example, gaps g1, g2 and g3 of FIG. 14) between the first group address electrode 1400 and the second group address electrode 1410 is excessively short, a noise may be generated due to the coupling between the first group address electrode 1400 and the second group address electrode 1410. Further, a current may flow between the first group address electrode 1400 and the second group address electrode 1410. On the other hand, when the shortest gap between the first group address electrode 1400 and the second group address electrode 1410 is excessively long, the problems illustrated in FIG. 15 may occur.

Considering this, the shortest gap between the first group address electrode 1400 and the second group address electrode 1410 may range from 0.1 to 2 times the largest width (for example, the widths W1 and W2) of at least one of the first group address electrode 1400 or the second group address electrode 1410.

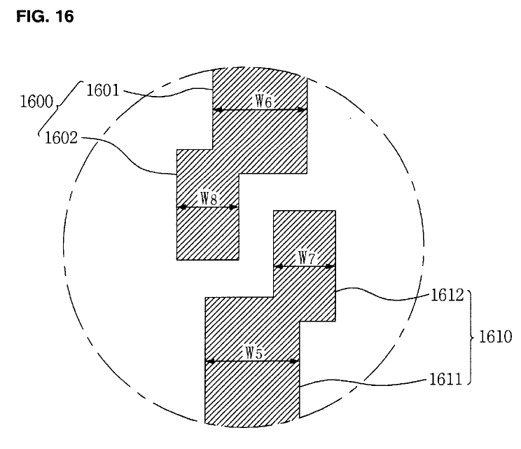

FIG. 16 illustrates another exemplary shape of the terminal portions of address electrodes near the division.

Referring to FIG. 16, a first group address electrode 1600 includes a first portion 1601 with a sixth width W6, and a second portion 1602 with an eighth width W8. A second group address electrode 1610 includes a first portion 1611 with a fifth width W5, and a second portion 1612 with a seventh width W7.

The second portion 1602 of the first group address electrode 1600 protrudes from the first portion 1601 in the downward and left direction, and the second portion 1612 of the second group address electrode 1610 protrudes from the first portion 1611 in the upward and right direction.

The sixth width W6 of the first portion 1601 may be more than or substantially equal to the eighth width w8 of the second portion 1602. Further, the fifth width W5 of the first portion 1611 may be more than or substantially equal to the seventh width W7 of the second portion 1612.

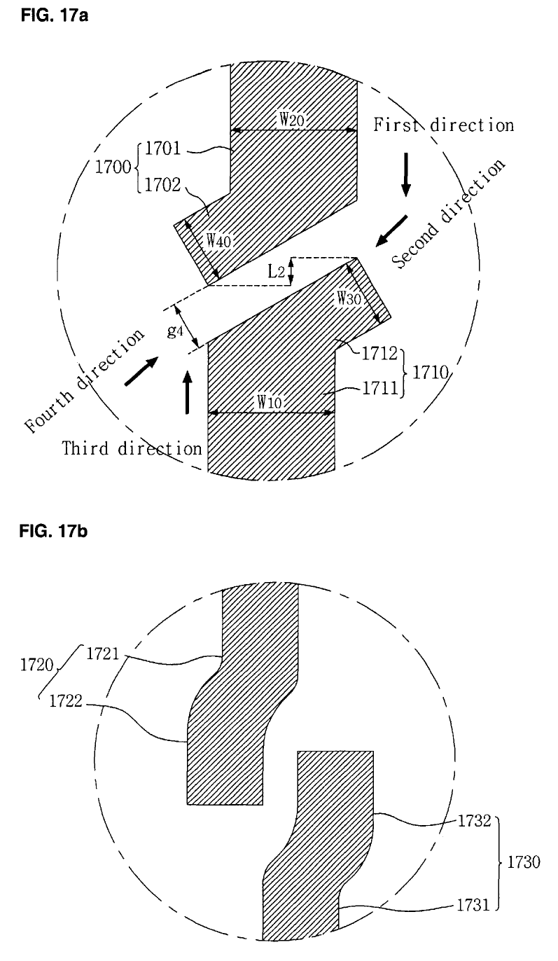

FIGS. 17a and 17b illustrate another exemplary shapes of the terminal portions of address electrodes near the division.

Referring to FIG. 17a, a first group address electrode 1700 includes a first portion 1701 protruding in a first direction, and a second portion 1702 protruding in a second direction.

A second address electrode 1710 includes a first portion 1711 protruding in a third direction, and a second portion 1712 protruding in a fourth direction. The third direction is opposite to the first direction. The fourth direction may be opposite to the second direction.

The second portion 1702 of the first group address electrode 1700 vertically overlaps the second portion 1712 of the second group address electrode 1710 by a length L2.

The second portion 1702 of the first group address electrode 1700 has a width W40, and the second portion 1712 of the second group address electrode 1710 has a width W30. The width W40 may be substantially equal to the width W30. The widths W40 and W30 may be less than or substantially equal to a width W20 of the first portion 1701 or a Width W10 of the first portion 1711.

Referring to FIG. 17b, a second portion 1722 of a first group address electrode 1720 and a second portion 1732 of a second group address electrode 1730 each include a portion with a curvature.

As explained above, the first group address electrode and the second group address electrode may have various shapes of terminal portions.

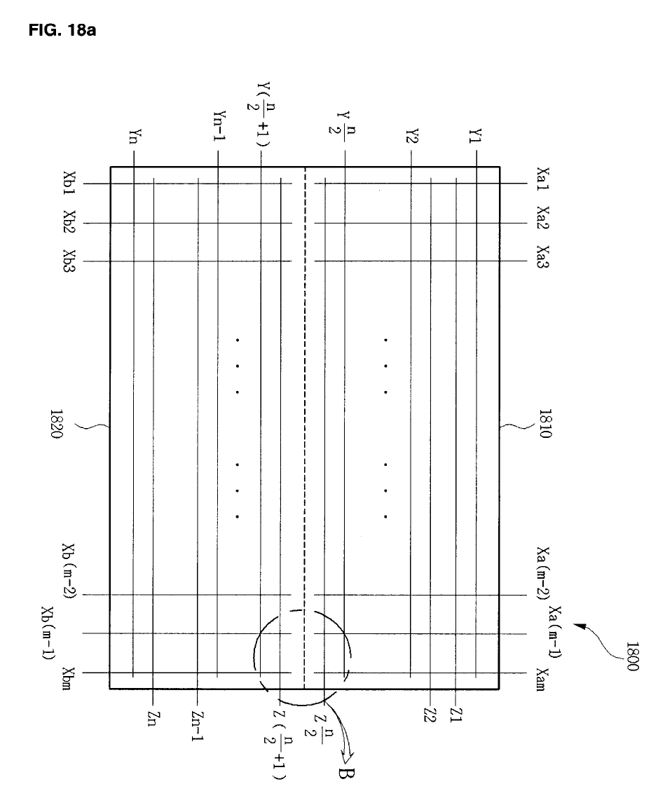

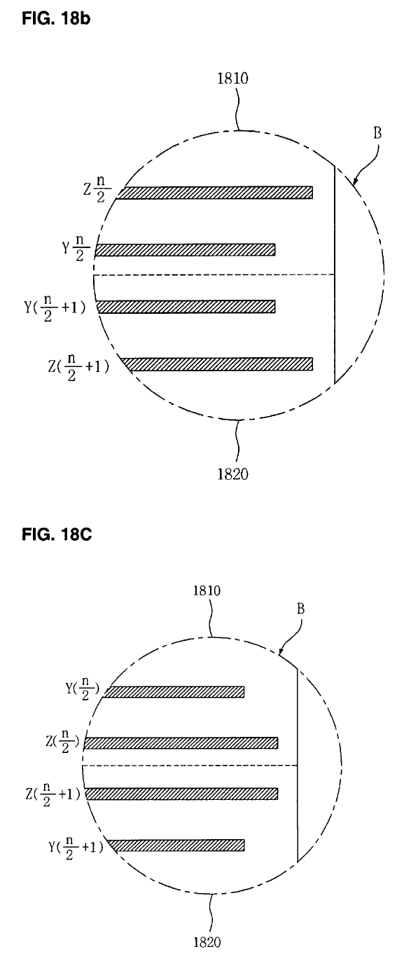

FIGS. 18a to 18c illustrate an exemplary arrangement of scan electrodes and sustain electrodes. Referring to FIG. 18a, in at least one of a first area 1810 or a second area 1820 of a plasma display panel 1800, two or more scan electrodes or two or more sustain electrodes are successively positioned. Also, two or more scan electrodes are successively positioned and then two or more sustain electrodes are successively positioned.

For example, in FIG. 18a, two adjacent scan electrodes and two adjacent sustain electrodes are alternately positioned in the first area 1810 or the second area 1820. In the arrangement as explained above, a coupling effect between the adjacent electrodes decreases such that the generation of noise is reduced.

The arrangement of electrodes in the first area 1810 may be symmetrical to the arrangement of electrodes in the second area 1820.

For example, as illustrated in FIG. 18b, two scan electrodes Y(n/2) and Y((n/2)+1), which are respectively positioned in the first area 1810 and the second area 1820, may be adjacent to each other. In such an arrangement, the coupling effect between the first area 1810 and the second area 1820 further decreases.

Alternatively, as illustrated in FIG. 18c, two sustain electrodes Z(n/2) and Z((n/2)+1), which are respectively positioned in the first area 1810 and the second area 1820, may be adjacent to each other.

Scan signals may be sequentially supplied to the scane electrodes in the first area 1810, starting from the first scan electrode Y1 and finishing at the (n/2)th scan electrode Yn/2. At the same time, scan signals may be sequentially supplied to the scan electrodes in the second area 1820, starting from the nth scan electrode Yn and finishing at the ((n/2)+1)th scan electrode Y(n/2)+1.

In this case, scan signals are simultaneously supplied to scan electrodes Yn/2 and Y(n/2)+1, which are mostly close to the boundary between the first area 1810 and the second area 1820. As a result, a noise is generated in the scan signals due to the coupling effect between the scan electrodes Yn/2 and Y(n/2)+1 such that an unstable address discharge is generated.

However, as illustrated in FIG. 18c, when the two sustain electrodes are disposed between the scan electrodes Yn/2 and Y(n/2)+1, the distance between the scan electrodes Yn/2 and Y(n/2)+1 is sufficiently wide such that the generation of noise in the scan signals is prevented and a stable address discharge is generated.

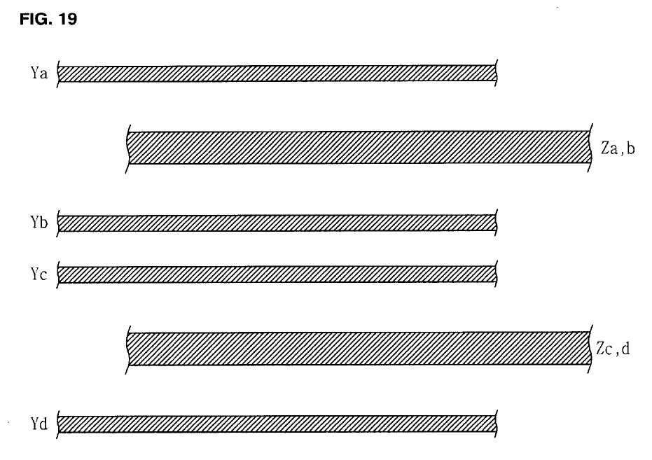

FIG. 19 illustrates another exemplary arrangement of scan electrodes and sustain electrodes. Referring to FIG. 19, a Ya scan electrode for discharge cell a, a Za,b sustain electrode for discharge cells a and b, a Yb scan electrode for discharge cell b, a Yc scan electrode for discharge cell c, a Zc,d sustain electrode for discharge cells c and d, and a Yd scan electrode for discharge cell d are disposed in that order.

Widths of the Za,b sustain electrode and the Zc,d sustain electrode may be more than widths of the Ya, Yb, Yc and Yd scan electrodes.

In FIG. 19, a sustain electrode for discharge cell a and a sustain electrode for discharge cell b are integrated into the Za,b sustain electrode, and a sustain electrode for discharge cell c and a sustain electrode for discharge cell d are integrated into the Zc,d sustain electrode.

As above, two sustain electrodes for two discharge cells may be integrated into one sustain electrode.

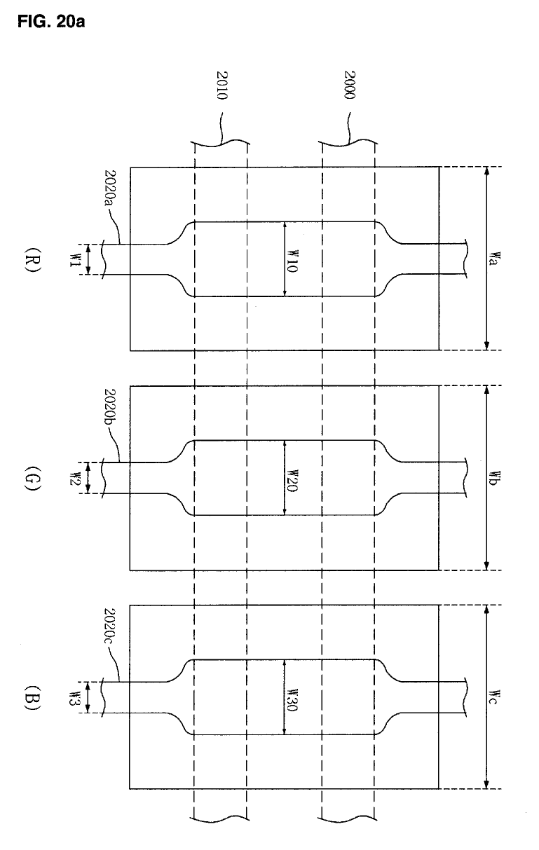

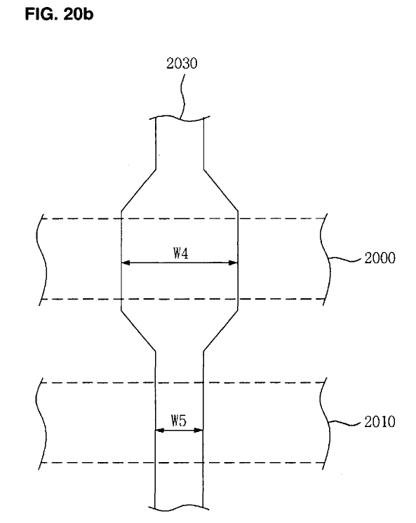

FIGS. 20a and 20b illustrate exemplary shapes of address electrodes. Referring to FIG. 20a, widths of address electrodes 2020a, 2020b and 2020c may change in a signal electrode. For example, widths W10, W20 and W30 of the address electrodes 2020a, 2020b and 2020c inside discharge cells are more than widths W1, W2 and W3 of the address electrodes 2020a, 2020b and 2020c outside the discharge cells.

The widths W10, W20 and W30 of the address electrodes 2020a, 2020b and 2020c over a scan electrode 2000 or a sustain electrode 2010 are more than the widths W1, W2 and W3 in another portion of the address electrodes 2020a, 2020b and 2020c. In such a configuration of the address electrodes 2020a, 2020b and 2020c, an address discharge is more stably generated by a scan signal supplied to the scan electrode 2000 and data signals supplied to the address electrodes 2020a, 2020b and 2020c.

Further, time required in scanning is reduced due to the stable address discharge. In other words, the width of the scan signal may be reduced such that the total driving time may also be reduced. Therefore, even when at least one subfield of a frame includes a pre-reset period prior to a reset period, the total driving time does not increase.

Further, the widths of the address electrode may be different in different types of discharge cells. For example, in a case where the discharge cell includes red, green, and blue discharge cells, the width W10 of the address electrode 2020a inside the red discharge cell may be different from the width W20 or W30 of the address electrode 2020b or 2020c inside the green or blue discharge cell.

To improve a color temperature of an image, it is advantageous that the width W30 of the address electrode 2020c inside the blue discharge cell is greater than the width W10 of the address electrode 2020a inside the red discharge cell.

To prevent a reduction in the luminance of an image, it is advantageous that the width W20 of the address electrode 2020b inside the green discharge cell is more than the width W10 of the address electrode 2020a inside the red discharge cell.

To improve the color temperature of the image, it is advantageous that a width Wc of the blue discharge cell is more than a width Wa of the red discharge cell. To prevent the reduction in the luminance of the image, it is advantageous that a width Wb the green discharge cell is more than the width Wa of the red discharge cell.

Referring to FIG. 20b, a width W4 of an address electrode 2030 over a scan electrode 2000 is greater than a width W5 of the address electrode 2030 over a sustain electrode 2010.

The reason that the width W4 is greater than the width W5 is that an address discharge mainly occurs between the address electrode 2030 and the scan electrode 2000.

Other implementations are within the scope of the following claims.

What is claimed is:

1. A plasma display panel comprising:
a scan electrode;
a sustain electrode positioned in parallel to the scan electrode;
an address electrode overlapping the scan electrode and the sustain electrode,
a partition configured to divide the address electrode into first and second sub-electrodes that are electrically isolated from one another; and
a scan driver configured to apply a first scan signal to the scan electrode during a first subfield, the first subfield comprising a reset period, a pre-reset period that immediately precedes the reset period, an address period and a sustain period.

2. The plasma display panel of claim 1, wherein the scan driver is further configured to apply a second scan signal to the scan electrode during a second subfield that follows the first subfield temporally, the second subfield consisting of a reset period, an address period and a sustain period.

3. The plasma display panel of claim 2, wherein the scan driver is further configured to apply a third scan signal to the scan electrode during a third subfield that follows the first subfield temporally, the third subfield comprising a pre-reset period, a reset period, an address period and a sustain period.

4. The plasma display panel of claim 1, further comprising a sustain driver configured to apply a first sustain signal to the sustain electrode during the first subfield, the first sustain signal being biased to a predetermined value during a period after the reset period of the first subfield.

5. The plasma display panel of claim 1, wherein each of the first sub-electrode and the second sub-electrode has a terminal portion near the partition, and wherein a width of the terminal portion of the first sub-electrode or the second sub-electrode dictates a separation between the first sub-electrode and the second sub-electrode.

6. The plasma display panel of claim 1, wherein each of the first sub-electrode and the second sub-electrode has a terminal portion near the partition, and wherein a distance between the first sub-electrode and the second sub-electrode ranges from 0.4 to 5 times a width of a widest of the terminal portions of the first sub-electrode and the second sub-electrode.

7. The plasma display panel of claim 6, wherein the distance between the first sub-electrode and the second sub-electrode ranges from 0.6 to 2.5 times the width of the widest of the terminal portions of the first sub-electrode and the second sub-electrode.

8. The plasma display panel of claim 1, wherein a width of the address electrode at a portion where the address electrode overlaps the scan electrode or the sustain electrode is greater that a width of the address electrode at a non-overlapping portion of the address electrode.

9. The plasma display panel of claim 1, wherein a width of the address electrode at a portion where the address electrode overlaps the scan electrode is greater than a width of the address electrode at another portion where the address electrode overlaps the sustain electrode.

10. The plasma display panel of claim 1, wherein the first scan signal has a first rising voltage characteristic and a second rising voltage characteristic during the reset period of the first subfield.

11. A plasma display panel comprising:
a screen;
a scan electrode;
a sustain electrode positioned in parallel to the scan electrode;
an address electrode positioned perpendicular to the scan electrode and the sustain electrode, the address electrode divided for dividing the screen into a plurality of smaller screens; and
a scan driver configured to apply a first scan signal to the scan electrode during a first subfield, the first subfield comprising a reset period, a pre-reset period that immediately precedes the reset period, an address period and a sustain period.

12. The plasma display panel of claim 11, wherein the scan driver is further configured to apply a second scan signal to the scan electrode during a second subfield, the second subfield consisting of a reset period, an address period and a sustain period.

13. The plasma display panel of claim 11, wherein the address electrode is divided into a first sub-electrode and a second sub-electrode, wherein each of the first sub-electrode and the second sub-electrode has a terminal portion near the division, and wherein a width of the terminal portion of the first sub-electrode or the second sub-electrode dictates a separation between the first sub-electrode and the second sub-electrode.

14. The plasma display panel of claim 11, wherein the address electrode is divided into a first sub-electrode and a second sub-electrode, wherein each of the first sub-electrode and the second sub-electrode has a terminal portion near the division, and wherein a distance between the first sub-electrode and the second sub-electrode ranges from 0.4 to 5 times a width of a widest of the terminal portions of the first sub-electrode and the second sub-electrode.

15. The plasma display panel of claim 14, wherein the distance between the first sub-electrode and the second sub-electrode ranges from 0.6 to 2.5 times the width of the widest of the terminal portions of the first sub-electrode and the second sub-electrode.

16. The plasma display panel of claim 11, wherein a width of the address electrode at a portion where the address electrode overlaps the scan electrode or the sustain electrode is greater that a width of the address electrode at a non-overlapping portion of the address electrode.

17. The plasma display panel of claim 11, wherein a width of the address electrode at a portion where the address electrode overlaps the scan electrode is greater than a width of the address electrode at another portion where the address electrode overlaps the sustain electrode.

18. A method of driving a plasma display panel comprising:
applying a first scan signal to a first scan electrode and a second scan electrode during a first subfield that includes a reset period, a pre-reset period that precedes the reset period, an address period and a sustain period;
applying a sustain signal to a sustain electrode during the first subfield; and
applying an address signal to a address electrode during the first subfield.

19. The method of claim 18, further comprising applying a second scan signal to the first scan electrode and the second scan electrode during a second subfield that follows the first subfield temporally, wherein the second subfield consists of a reset period, an address period and a sustain period.

20. The method of claim 19, further comprising applying a third scan signal to the first scan electrode and the second scan electrode during a third subfield that follows the first subfield temporally, wherein the third subfield comprises a pre-reset period, a reset period, an address period and a sustain period.
